(19) United States
(12) Patent Application Publication
(10) Pub. No.: US 2007/0050458 A1
(43) Pub. Date: Mar. 1, 2007

(54) Method and software for enabling portable media players to select on demand media from the internet and to download the media directly to the players

(75) Inventors: Christian Rotzoll, Weimar (DE); Hagen Christian Toennies, Weimar (DE)

Correspondence Address: Tim Shen,;Attorney at Law, Suite 106, 14125 Memorial Dr., Houston, TX, 77079, US

(73) Assignee: Podcast Ready, Inc.

(21) Appl. No.: 11/387,216

(22) Filed: Mar. 23, 2006

Related U.S. Application Data
(60) Provisional application No. 60/711,891, filed on Aug. 26, 2005.

(51) Int. Cl. G06F 15/16

(52) U.S. Cl. 709/206

(57) ABSTRACT

The present invention provides a novel method for selecting and receiving on demand media from the Internet and downloading the on demand media directly to a portable media player. The present invention provides a novel media catching software stored in the portable media player. When the portable media player is connected to a personal computer, the personal computer runs the catching program directly from the portable media player without having to install the program on the computer. The catching program manages the user's selection of on demand media sources on the Internet. Additionally, the catching program causes a computer providing Internet access to download on demand media directly to the portable media player without the need of an intermediate step of storing on demand media to the computer or the need for file synchronization between the computer and the player. The present invention simplifies the media receiving process, allowing the portable media player connected to a computer having Internet access to download on demand media directly to the player.

### CROSS-REFERENCE TO RELATED APPLICATIONS

This application claims the benefit of provisional application Ser. No. 60/711,891, filed Aug. 26, 2005, the contents of such application being hereby incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

This invention relates to on demand audio and video on the Internet, specifically to the receiving and downloading of on demand media to portable media players.

2. Background Art

On demand audio and video media technology has advanced greatly in the past couple of years, allowing users to choose and select the media from the Internet and download the selected media to any device desired by the user. Once downloaded to their portable players, users can listen to the audio or watch the video at their convenience and without the need to connect to a host personal computer or the Internet.

On demand media has been used in the cable TV industry to provide movies to users at any time the user desires. The user may contact the cable TV provider or select a movie through a set top box and the desired movie may be provided nearly instantaneously to the user at home. Another example of on demand media is using a VCR or TiVo to record the desired program and play it at a later time that is convenient for the user.

Portable media devices have recently begun using on demand technology. One common on demand device is the portable MP3 player, which can play music downloaded from the Internet. Some portable devices are capable of playing video as well. These portable or handheld devices have allowed people to choose their music or video and to take such music and/or video wherever they go. The user can select music or video from various providers on the Internet. For example, Apple Computer Inc. has a proprietary online service called iTunes, which allows users to select and purchase music online and then download the music files to the user's personal computer and then to the user's iPod player, if desired. This process requires the music files to be stored first in the personal computer before the music files can be transferred to the iPod player.

Another type of on demand media source is podcasting, which allows users to subscribe to audio and/or video feeds from the Internet for download to a personal computer or a portable media device, such as an MP3 player. Podcasting has been referred to as “Radio On Demand” or “Personal On Demand Broadcasting” because a listener can choose what he wants to hear, when he wants to hear it, and on which portable device he wants to play it.

According to the Internet encyclopedia, Wikipedia, “podcasting is distinct from other types of online media delivery because of its subscription model, which uses the RSS 2.0 XML (or RDF XML) format to deliver an enclosed file [typically an audio file in MP3 format]. Podcasting enables independent producers to create self-published, syndicated ‘radio shows’ and gives broadcasting radio programs a new distribution method. Listeners may subscribe to feeds using ‘podcatching’ software (a type of aggregator), which periodically checks for and downloads new content automatically.”

The process for retrieving a podcast is as follows: First, the user selects or subscribes to a podcaster's channel according to his or her interest. For example, the user may be interested in sports and may subscribe to a channel discussing local sports. The broadcaster or creator of the channel typically adds new entries to the channel whenever new content is available. Next, a podcatching software is used to cause the computer to automatically scan channels that the user is subscribed to for new content. When new content is detected, the computer downloads the new content onto its system. Finally, the new media content is transferred to the portable media device when the portable media device is connected to the computer. The new content is typically an audio file, but the proliferation of portable video devices is increasing the popularity of audio/video files.

The process for selecting and subscribing to podcasts is complicated and downloading of selected podcasts is a multi-step process, requiring the use of a computer having podcatching software in order to accomplish the download. Therefore, there is a need to simplify the process for selecting, subscribing, and downloading on demand media, such as podcasting, to portable media players.

### BRIEF SUMMARY OF THE INVENTION

The present invention simplifies the process of selecting, receiving and downloading on demand media to a portable media player. Typically, a portable media player must transfer new selections of on demand media to a portable media player using two or more steps. First, a “podcatching” or “catching” program running on a computer causes desired media to be downloaded from the Internet to the hard disk of the computer. Second, the downloaded media is transferred from the hard disk of the computer to the portable media player in a synchronized manner.

In the present invention, the catching software is installed directly on the portable media player. The catching software is started as an application by a personal computer once the portable media player is connected to the personal computer. The catching software causes the personal computer to download selected on demand media from the Internet and store the media directly to the portable media player.

The present invention allows on demand media to be transferred to the portable media player in one step instead of the two steps required when the portable media player is connected to a personal computer. The present invention does not use hard drive space on the computer because the on demand media is stored directly on the portable media player.

Additionally, the typical portable media player requires the media player to be connected to the same computer on which the user subscribed to the content. This is because the catching program that manages the user's subscriptions is on the user's computer. The present invention allows the portable media player to be connected to any computer to download new content. Because the catching software is stored on the portable media player, the desired on demand media can be retrieved from any computer or device with Internet access. Because the media and catching software are not stored on the computer's hard disk, no space is used on the computer's hard disk. Finally, because the portable media player downloads the on demand media directly from the Internet, no file synchronization is needed between the computer and the portable media player.

### BRIEF DESCRIPTION OF THE SEVERAL VIEWS OF THE DRAWINGS

FIG. 1 illustrates the base situation of the portable on demand media player.

FIG. 2 illustrates the typical portable on demand media player.

FIG. 3 illustrates the first step to transferring data to a portable on demand media player.

FIG. 4 illustrates the second step to transferring data to a portable on demand media player.

FIG. 5 illustrates a preferred embodiment of a portable on demand media player configuration in accordance with the invention.

FIG. 6 illustrates the only step needed to transfer data to a portable on demand media player in accordance to the present invention.

FIG. 7 illustrates the portable on demand player system in accordance with one embodiment of the invention.

FIG. 8 illustrates the software system of the portable on demand player in accordance with one embodiment of the invention.

FIG. 9 illustrates the subscribing interface of the portable on demand player in accordance with one embodiment of the invention.

FIG. 10 illustrates the content scanner of the portable on demand player in accordance with one embodiment of the invention.

FIG. 11 illustrates the content aggregation of the portable on demand player in accordance with one embodiment of the invention.

FIG. 12 illustrates the content storage of the portable on demand player in accordance with one embodiment of the invention.

FIG. 13 shows an example text and format of a RSS feed.

Like elements in the various figures are denoted by like reference numerals for consistency.

### DETAILED DESCRIPTION OF THE INVENTION

A “portable on demand media receiver” is a small, portable device that is capable of playing audio and/or video files. In the context of podcasting, an “on demand media channel” is an abstract list of several on demand media file locations on the Internet. Such a channel is technically described in a XML dialect (RSS/OPML/ATOM) and is also recallable by a URL (Uniform Resource Locator). For example a “podcast RSS feed” is a media channel for on demand audio content.

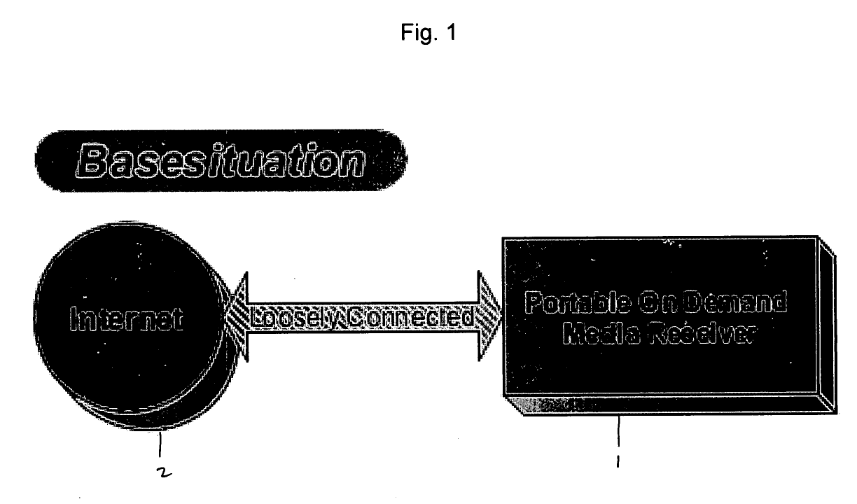

In the typical situation shown FIG. 1, a portable on demand media receiver (i.e., a portable media player) 1 must be connected to the Internet 2 to read the media channel content lists and to download the on demand audio content to the portable media player. For example, the portable media player must be connected to a computer that has Internet access to scan a RSS feed and to download on demand audio and/or video content. However, once the content has been downloaded, the player does not need to be connected to the Internet in order to play the media.

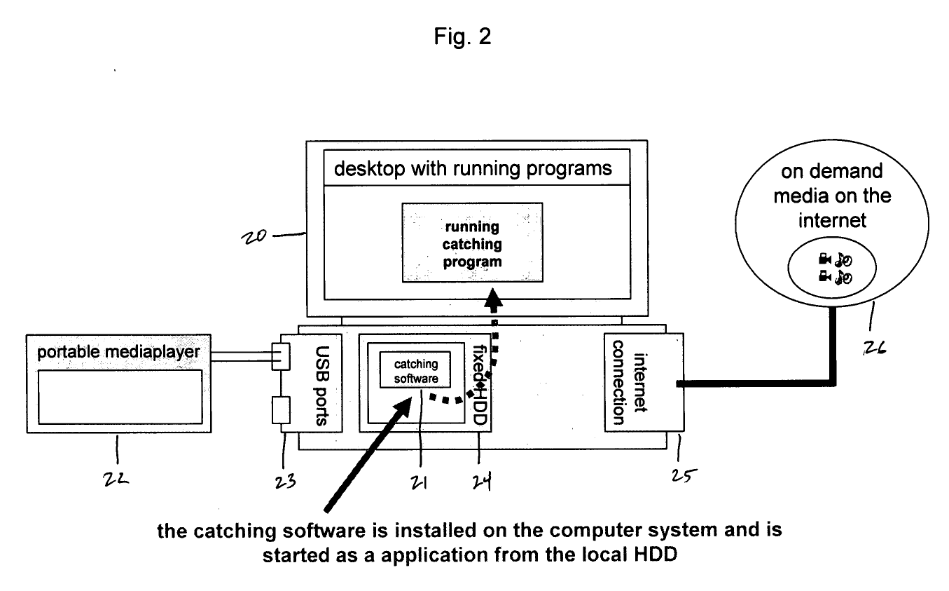

A typical portable media player is shown in FIG. 2. A computer 20 capable of running catching software 21 is connected to the portable media player 22 through a USB port 23. The computer's hard drive 24 stores the catching software, and is also connected to the Internet 25. The portable media player retrieves on demand media from the Internet 26 in two steps.

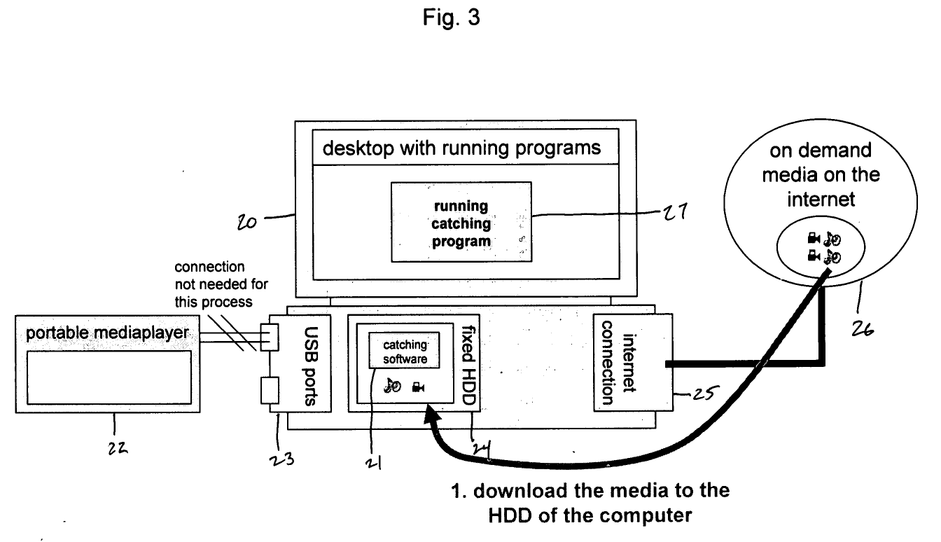

In the first step, shown in FIG. 3, the running catching program 27 executed by the computer 20 causes the computer to download user-requested on demand media 26 from the Internet 25. The on demand media is stored in the hard disk 24 of the computer. Note that the portable media player 22 does not need to be connected to the computer during this step, but the computer must be connected to the Internet 25. The on demand media is downloaded to the hard disk 24 of the computer, regardless of whether the portable media player is connected, when the catching software is running.

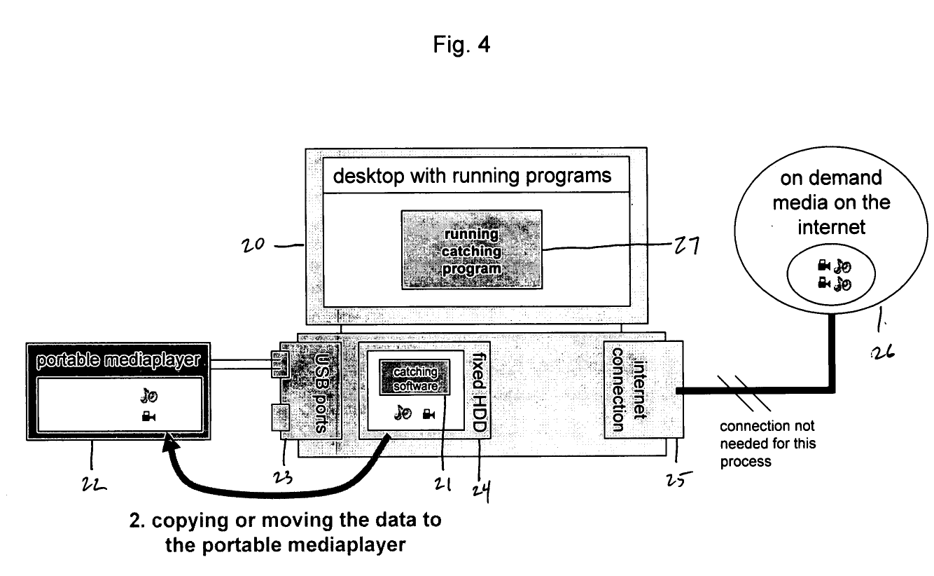

In the second step, shown in FIG. 4, the running catching program 27 on the computer 20 causes the on demand media, stored on the hard disk 24 of the computer, to be transferred to the portable media player 22. This step requires the portable media player to be connected to the computer through a USB port 23. However, the computer 20 does not need to be connected to the Internet 25 during this step.

The present invention improves on the typical portable media player by simplifing the process of retrieving on demand media from the Internet. In the present invention, a novel software program (commonly referred to as “podcatching” or “catching” software) is installed on a portable media player to make the device capable of retrieving on demand media through the Internet. The software becomes an essential part of the portable media player and has the following three properties: 1) the catching software is stored directly on a portable media player; 2) the catching software is capable of managing and subscribing to several on demand media channels; and 3) the catching software is capable of downloading on demand media listed in the media channels directly to the portable media player.

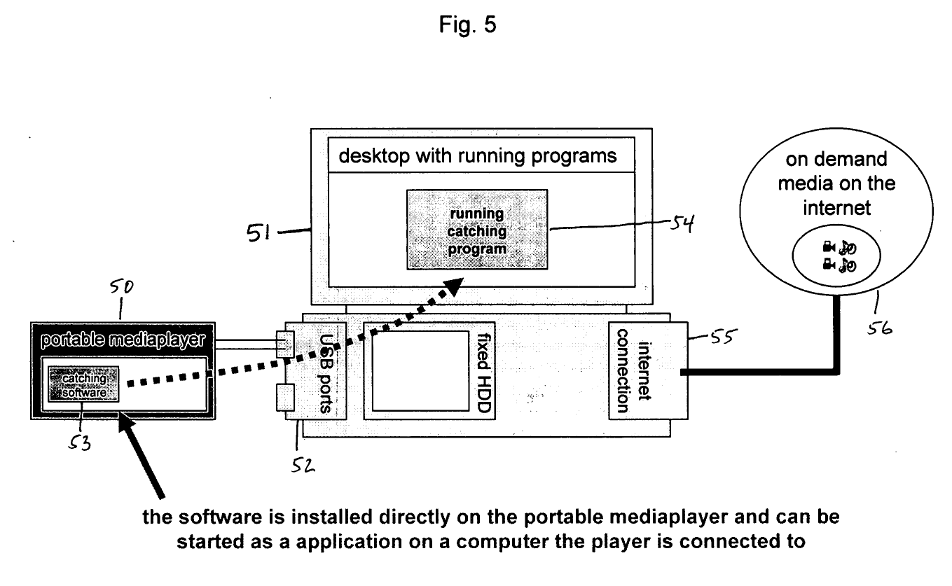

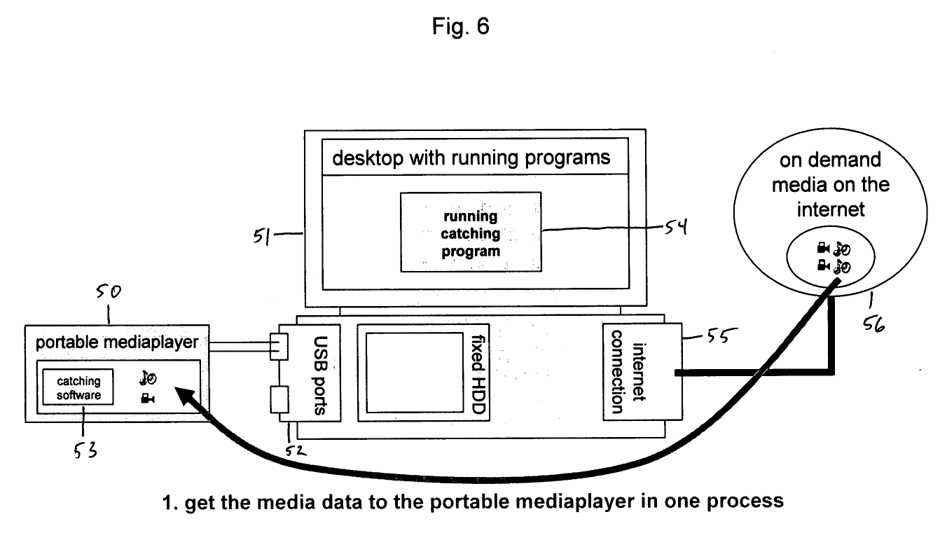

In the preferred embodiment of the invention, shown in FIG. 5, the portable media player 50 is connected to a computer 51 through a USB port 52. The portable media player 50 stores the catching software 53. When the portable media player 50 is connected to the computer 51, the computer 51 automatically begins executing the catching program 54. In the alternative, the computer may prompt the user to execute the program or the user may run the program at any time. As shown in FIG. 6, the running catching program 54 causes the computer 51 to retrieve the on demand media 56 from the Internet 55, and then the on demand media 56 is stored directly on the portable media player 50. The present invention requires only one step to retrieve the on demand media and stores it on the portable media player.

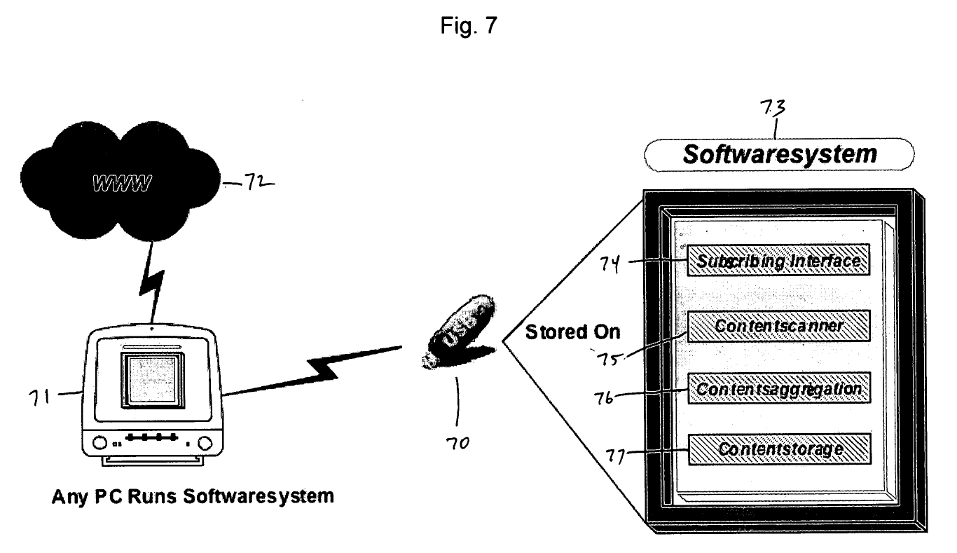

By connecting the portable media receiver 70 to a personal computer 71 with Internet connectivity 72, as shown in FIG. 7, the user can select and download on demand media content. If the portable media player 70 is connected to a personal computer 71 via a USB port, then the portable media player is handled as an exchangeable drive by the personal computer according to USB Storage Media (USM) specifications or equivalent. However, alternative methods of supporting an exchangeable drive may be used, such as wireless USB, Firewire (IEEE 1394), Bluetooth, infrared connection and the like. The software system 73 includes a subscribing interface 74, content scanner 75, content aggregation 76, and content storage 77. The software system 73 stored on the portable media player 70 hard drive or memory can be started as an application on the personal computer 71. The software system can use the available Internet connectivity 72 and download the on demand media content to the portable media player 70 for further use. Alternatively, the portable media player 70 may be connected to other sources of Internet connectivity, including but not limited to: a laptop, a cell phone with Internet connectivity capabilities, or a portable handheld Internet-capable device like a Treo Smartphone, a Palm Pilot, an HP iPaq, and the like.

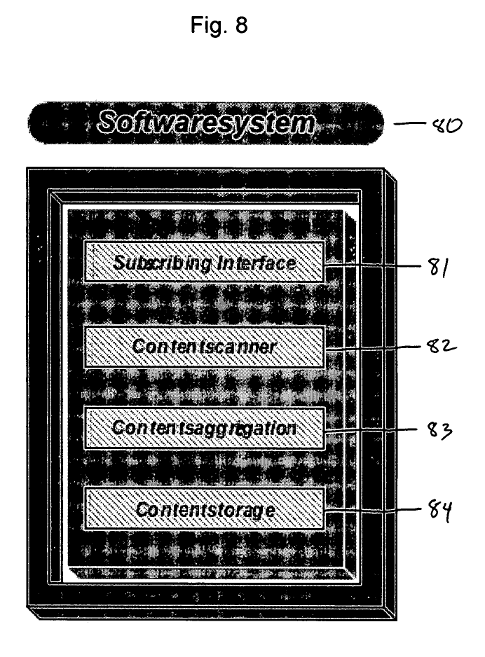

The main functions of the software system in FIG. 8 include: a) managing and subscribing to media channels. The software system 80 provides a subscribing interface 81 to manage the subscription list of media channels; and b) downloading and storing on demand media on the portable media player. Therefore the software needs the ability to scan for new media content using a content scanner 82; the ability to collect/download the media files using a content aggregation 83; and the ability to store the content to the device using content storage 84.

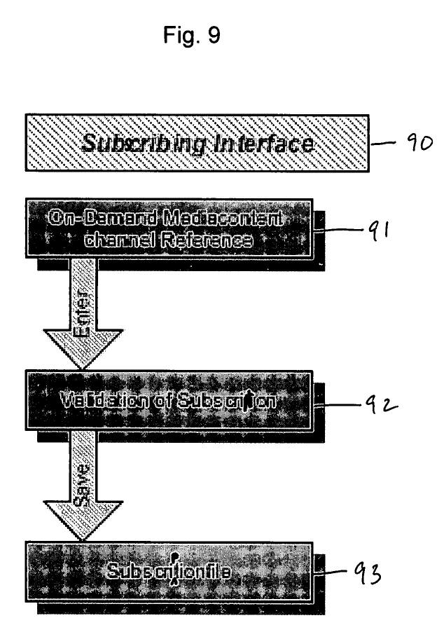

In FIG. 9, the “subscribing interface” 90 manages the user's subscriptions to media channels, and the software stores the subscriptions in a subscription file (OPML file). If the user wants to subscribe to a new media channel he must enter a reference to the channel that he wants to subscribe to 91. After validation of the reference 92, the new subscription is stored into the subscription file 93. By default this file is stored locally on the portable media player.

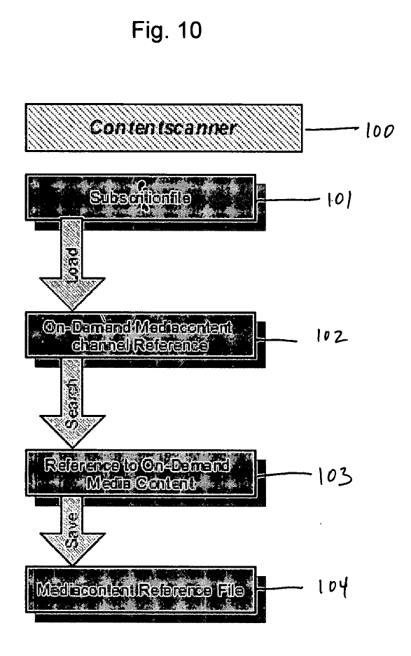

To start a download process in FIG. 10, the “content scanner” 100 starts by loading all the media channel references from the subscription file 101. Each media channel description file corresponding to the media channel references 102 is loaded from the Internet. All of the media channel description files are compared to the on demand media channel references 103. All matched references to new on demand media files (audio and/or video files) are stored temporarily in the main memory of the computer for further usage 104.

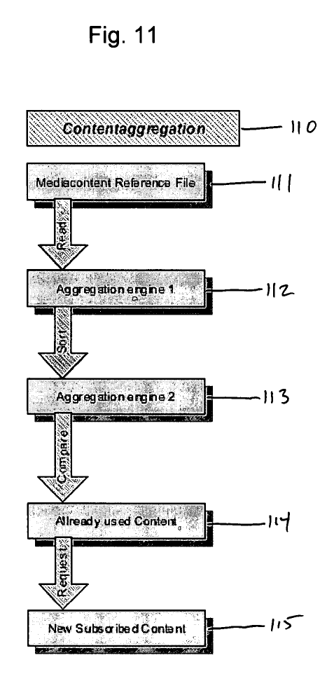

The “content aggregation” 110 process in FIG. 11 contains several steps. The matched media channel references is read 111, and gets sorted by publication dates (e.g., newest first) and/or size (e.g., smallest first) 112. Media channel references that have already been downloaded are filtered from a download list by comparing media channel references in the list with a list of already downloaded files flagged in a history file 113. Double entries are removed from the download list 114. The download list of media channel references to new on demand media files remains in the main memory 115. At the end of the download process all files in the remaining download list are retrieved from the Internet. At the same time, the “content storage” process monitors the storage of the on demand files to the portable media player.

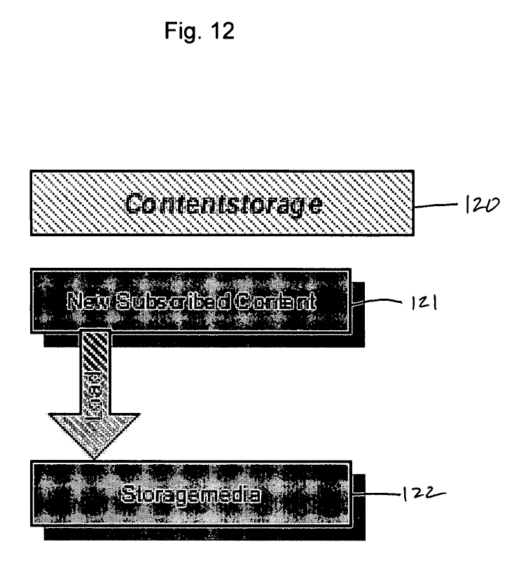

The “content storage” 120 in FIG. 12 stores the media files 121 to the portable media player 122. The “content storage” process checks the stored media files to determine if the on demand media files have been stored properly, and after every successful download the reference is stored in the history file.

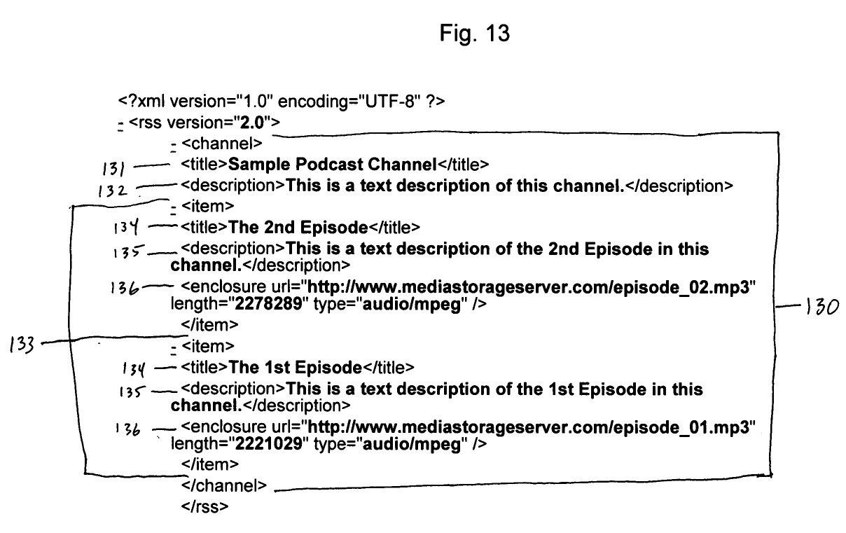

FIG. 13 shows an example text of an RSS feed. A RSS channel 130 typically contains a title 131, link (not shown), and description 132. The title 131 provides the name of the channel. The link provides the URL or HTML website for the channel. Finally, the description 132 provides a description of the channel. The RSS 2.0 specification also provides for other optional channel elements. A RSS channel 130 may also contain several items 133. Each item is similar to an episode of a TV show or a story from a newspaper or magazine. Each item has a title 134 for the item and a description 135 of the item. Additionally, the item may contain a link to a URL 136 for the item. The link provides the user with the URL to retrieve the file that corresponds to the item. Optionally, each item may contain information regarding the author, category, comments, enclosure, “guid”, “pubDate”, and source.

The present invention improves downloading of on demand media to portable media players by allowing the media to be downloaded in fewer steps. The present invention downloads on demand media to a portable media player in a single step, instead of two or more steps required by typical portable media players. Additionally, most portable media players must be connected to a particular personal computer, on which the catching software is installed, to properly download on demand media. Because the software system is stored directly on the portable media player, the present invention allows the portable media player to download on demand media by connecting to any computer that has Internet connectivity. No catching software is needed on the computer. Thus, the user is not tied to just one computer. For example, the user can connect the portable media player to a computer at work or in a computer lab at school and properly download on demand media. The user does not have to connect the portable media player to his personal computer or any particular computer in order to receive on demand media from the Internet.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A portable on demand media apparatus comprising:
a portable media player that contains catching software,
wherein the catching software manages and subscribes to one or a plurality of on demand media channels, and
a Internet access device connected to the portable media player that runs the catching software; and
the one or plurality of on demand media files are downloaded directly to the portable media player based on the one or plurality of on demand media channels that a user has subscribed to.

2. The on demand media receiver apparatus in claim 1, wherein the Internet access device is a personal computer, a laptop, a portable handheld device, or a cell phone.

3. The on demand media receiver apparatus in claim 1, wherein the on demand media channel is an abstract list of several on demand media files located on the Internet.

4. The on demand media receiver apparatus in claim 3, wherein the on demand media files are provide via a RSS feed.

5. The on demand media receiver apparatus in claim 1, wherein the user enters a reference to the on demand media channel to subscribe to a new on demand media channel.

6. The on demand media receiver apparatus in claim 5, wherein a subscription file is stored, after the subscription is validated, in the portable media player.

7. The on demand media receiver apparatus in claim 6, wherein media channel references are loaded from the subscription file.

8. The on demand media receiver apparatus in claim 7, wherein media channel description files are loaded from the Internet; and
the media channel description files are searched for on demand media references.

9. The on demand media receiver apparatus in claim 8, wherein references to new on demand media files are temporarily stored.

10. The on demand media receiver apparatus in claim 9, wherein the references to new on demand media files are sorted by size or publication dates.

11. The on demand media receiver apparatus in claim 10, wherein the references to new on demand media files are compared to a history file; and
duplicates or double entries of the references to new on demand media files are removed.

12. The on demand media receiver apparatus in claim 11, wherein the remaining references to new on demand media files are used to download on demand media files directly to the portable media player; and
after a successful download of the on demand media file to the portable media player, the reference to new on media files is stored in the history file.

13. A method for retrieving on demand media for a portable device comprising:
a portable media player that contains catching software,
wherein the catching software manages and subscribes to one or a plurality of on demand media channels, and
the catching software runs on a Internet access device connected to the portable media player; and
the one or plurality of on demand media files are downloaded directly to the portable media player based on the one or plurality of on demand media channels that a user has subscribed to.

14. The method for retrieving on demand media for a portable device in claim 13, wherein the Internet access device is a personal computer, a laptop, a cell phone, or a portable handheld device.

15. The method for retrieving on demand media for a portable device in claim 13, wherein the on demand media channel is an abstract list of several on demand media files located on the Internet.

16. The method for retrieving on demand media for a portable device in claim 15, wherein the on demand media files are provided via a RSS feed.

17. The method for retrieving on demand media for a portable device in claim 13, wherein the user enters a reference to the on demand media channel to subscribe to a new on demand media channel.

18. The method for retrieving on demand media for a portable device in claim 17, wherein a subscription file is stored, after the subscription is validated, in the portable media player.

19. The method for retrieving on demand media for a portable device in claim 18, wherein media channel references are loaded from the subscription file.

20. The method for retrieving on demand media for a portable device in claim 19, wherein media channel description files are loaded from the Internet; and
the media channel description files are searched for on demand media references.

21. The method for retrieving on demand media for a portable device in claim 20, wherein references to new on demand media files are temporarily stored.

22. The method for retrieving on demand media for a portable device in claim 21, wherein the references to new on demand media files are sorted by size or publication dates.

23. The method for retrieving on demand media for a portable device in claim 22, wherein the references to new on demand media files are compared to a history file; and
duplicates or double entries of the references to new on demand media files are removed.

24. The method for retrieving on demand media for a portable device in claim 23, wherein the remaining references to new on demand media files are used to download on demand media files directly to the portable media player; and
after a successful download of the on demand media file to the portable media player, the reference to new on media files is stored in the history file.

25. A method for receiving on demand media comprising the steps:
a user subscribing to a new media channel by entering a reference;
storing a subscription in a subscription file after the reference is validated on a portable media player;
loading media channel references from the subscription file to a personal computer;
loading media channel description files from the Internet and searching the media channel description files for on demand media references;
temporarily storing references to new on demand media files;
sorting the references to new on demand media files by publication dates and sizes;
removing duplicates of the reference to new on demand media files;
downloading on demand media files based on the remaining references to new on demand media files from the Internet;
storing the on demand media files to the portable media player; and
after the on demand media file is successfully stored, the reference to the new on demand media file is stored in the history file.

26. A method for retrieving on demand media for a portable media player comprising:
a portable media player with catching software installed;
the catching software installed on the portable media player is started as an application on a Internet access device; and
the catching software causes the Internet access device to retrieve on demand media from the Internet and store the media directly to the portable media player.

27. The method for retrieving on demand media for a portable media player in claim 26, wherein the Internet access device is a personal computer, a laptop, a cell phone, or a portable handheld device.

28. A portable on demand media apparatus comprising:
a portable media player means with catching software installed; and
a software execution means connected to the portable media player connected to the Internet, wherein
the software execution means retrieves on demand media from the Internet and stores the media directly to the portable media player.
